(19) United States
(12) Patent Application Publication
(10) Pub. No.: US 2016/0322854 A1
(43) Pub. Date: Nov. 3, 2016

(54) WEARABLE RECEIVE COILS FOR WIRELESS POWER TRANSFER WITH NO ELECTRICAL CONTACT

(71) Applicant: QUALCOMM INCORPORATED, SAN DIEGO, CA (US)

(72) Inventor: SEONG HEON JEONG, SAN DIEGO, CA (US)

(21) Appl. No.: 15/000,901

(22) Filed: Jan. 19, 2016

Related U.S. Application Data
(60) Provisional application No. 62/155,037, filed on Apr. 30, 2015.

(51) Int. Cl. H02J 7/02; H01F 41/071; H02J 7/04

(52) U.S. Cl. CPC H02J 7/025; H02J 7/04; H01F 41/071

(57) ABSTRACT

A wearable apparatus configured to wirelessly receive charging power is provided. The apparatus comprises a band. The apparatus comprises a first receive coil wound in a clockwise direction along a first portion of the band as viewed from a direction normal to a cross section enclosed by the first receive coil. The apparatus comprises a second receive coil wound in a counterclockwise direction along a second portion of the band as viewed from the direction normal to the cross section. The apparatus comprises a parasitic coil overlapping a portion of the first receive coil and a portion of the second receive coil. The first receive coil is not electrically connectable to the second receive coil at distal ends of the band. The apparatus further comprises one or more resonant circuits comprising the first receive coil and the second receive coil.

### CROSS REFERENCE TO RELATED APPLICATIONS

This Application claims priority to Provisional Application No. 62/155,037 entitled “WRISTBAND RESONATORS FOR WIRELESS POWER TRANSFER WITH NO ELECTRICAL CONTACT AT A WRISTBAND CLASP” filed Apr. 30, 2015. The disclosure of Provisional Application No. 62/155,037 is hereby expressly incorporated in its entirety by reference herein.

### FIELD

This application is generally related to wireless transfer of charging power, and more specifically to wearable receive coils for wireless power transfer with no electrical contact at a band clasp.

### BACKGROUND

Wireless charging of wearable electronic devices may require electrical connection at a clasp of the band of the wearable device in order to provide complete turns for receive coils located within the band of the wearable device. However, there are implementations in which it may be desirable for the wearable device to be wirelessly chargeable without the requirement of an electrical connection at a clasp of the band of the wearable electronic device. Thus, wearable receive coils for wireless power transfer with no electrical contact at a band clasp are desirable.

### SUMMARY

In some implementations, a wearable apparatus configured to wirelessly receive charging power is provided. The apparatus comprises a band. The apparatus comprises a first receive coil wound in a clockwise direction along a first portion of the band as viewed from a direction normal to a cross section enclosed by the first receive coil. The apparatus comprises a second receive coil wound in a counterclockwise direction along a second portion of the band as viewed from the direction normal to the cross section.

In some other implementations, a method for wirelessly receiving charging power by a wearable apparatus is provided. The method comprises, under influence of a magnetic field, generating a first current via a first receive coil wound in a clockwise direction along a first portion of a band as viewed from a direction normal to a cross section enclosed by the first receive coil. The method comprises, under influence of the magnetic field, generating a second current via a second receive coil wound in a counterclockwise direction along a second portion of the band as viewed from the direction normal to the cross section. The method further comprises charging or powering the wearable apparatus utilizing the first current and the second current.

In yet other implementations, a method for fabricating a wearable apparatus configured to wirelessly receive charging power is provided. The method comprises winding a first receive coil in a clockwise direction along a first portion of a band as viewed from a direction normal to a cross section enclosed by the first receive coil. The method comprises winding a second receive coil in a counterclockwise direction along a second portion of the band as viewed from the direction normal to the cross section.

In yet other implementations, a wearable apparatus configured to wirelessly receive charging power is provided. The wearable apparatus comprises first means for generating a current under influence of a magnetic field, the first means wound in a clockwise direction along a first portion of a band as viewed from a direction normal to a cross section enclosed by the first means. The wearable apparatus comprises second means for generating a current under influence of the magnetic field, the second means wound in a counterclockwise direction along a second portion of the band as viewed from the direction normal to the cross section.

### BRIEF DESCRIPTION OF THE DRAWINGS

FIG. 1 is a functional block diagram of a wireless power transfer system, in accordance with some exemplary implementations.

FIG. 2 is a functional block diagram of a wireless power transfer system, in accordance with some other exemplary implementations.

FIG. 3 is a schematic diagram of a portion of transmit circuitry or receive circuitry of FIG. 2 including a transmit or receive coupler, in accordance with some exemplary implementations.

FIG. 4 is an illustration of a wearable device including a receive coil, in accordance with some implementations.

FIG. 5 is an illustration of the first receive coil and the second receive coil within a band in a wearable device and a planar transmit coil of a wireless transmitter, in accordance with some implementations.

FIG. 6 shows a flattened version of the first receive coil and the second receive coil of a receive coil in a wearable device and a cut-away plane pertaining to magnetic flux shown in FIGS. 7 and 8, in accordance with some implementations.

FIG. 7 is an illustration of exemplary magnetic field vectors that would be generated by currents induced in the first receive coil and the second receive coil of FIG. 6 under influence of a magnetic field generated by a transmit coil disposed below a charging surface, in accordance with some implementations.

FIG. 8 is another illustration of exemplary magnetic field vectors that would be generated by currents induced in the first receive coil and the second receive coil of FIG. 6 under influence of a magnetic field generated by a transmit coil disposed below the charging surface, in accordance with some implementations.

FIG. 9 illustrates a 3 dimensional view and a flattened view of a first receive coil and a second receive coil in a wearable device that partially overlap one another, in accordance with some implementations.

FIG. 10 illustrates a 3 dimensional view and a flattened view of a first receive coil and a second receive coil in a wearable device that do not overlap one another, in accordance with some implementations.

FIG. 11 illustrates a 3 dimensional view and a flattened view of a parasitic coil that partially overlaps each of a first receive coil and a second receive coil in a wearable device, in accordance with some implementations.

FIG. 12 illustrates a 3 dimensional view and a flattened view of a parasitic coil that partially overlaps each of a first receive coil and a second receive coil in a wearable device, in accordance with some implementations.

FIG. 13 is a flowchart depicting a method for wirelessly receiving charging power by a wearable apparatus, in accordance with some exemplary implementations.

FIG. 14 is a flowchart depicting a method for manufacturing a wearable apparatus configured to wirelessly receive charging power, in accordance with some exemplary implementations.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured, or coupled by a “receive coupler” to achieve power transfer.

The terminology used herein is for the purpose of describing particular implementations only and is not intended to be limiting on the disclosure. It will be understood that if a specific number of a claim element is intended, such intent will be explicitly recited in the claim, and in the absence of such recitation, no such intent is present. For example, as used herein, the singular forms “a,” “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

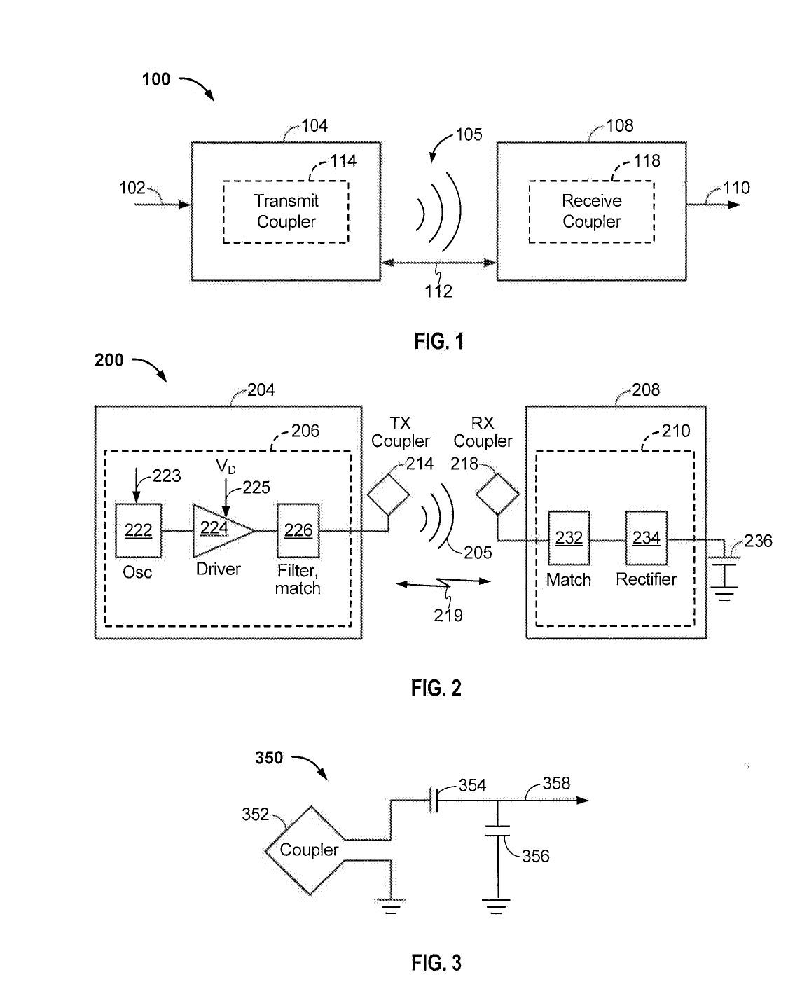

FIG. 1 is a functional block diagram of a wireless power transfer system 100, in accordance with some exemplary implementations. Input power 102 may be provided to a transmitter 104 from a power source (not shown) to generate a wireless (e.g., magnetic or electromagnetic) field 105 via a transmit coupler 114 for performing energy transfer. The receiver 108 may receive power via a receive coupler 118 when the receiver 108 is located in the wireless field 105 produced by the transmitter 104. The wireless field 105 corresponds to a region where energy output by the transmitter 104 may be captured by the receiver 108. A receiver 108 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the transmit coupler 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are minimal. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the transmit coupler 114 to the receive coupler 118, residing in the vicinity of the wireless field 105, rather than propagating the energy from the transmit coupler 114 into free space. Resonant inductive coupling techniques may thus allow for improved efficiency and, power transfer over various distances and with a variety of inductive coupler configurations.

In some implementations, the wireless field 105 corresponds to the “near-field” of the transmitter 104. The near-field may correspond to a region in which there are strong reactive fields resulting from the currents and charges in the transmit coupler 114 that minimally radiate power away from the transmit coupler 114. The near-field may correspond to a region that is within about one wavelength (or a fraction thereof) of the transmit coupler 114. Efficient energy transfer may occur by coupling a large portion of the energy in, the wireless field 105 to the receive coupler 118 rather than propagating most of the energy in an electromagnetic wave to the far field. When positioned within the wireless field 105, a “coupling mode” may be developed between the transmit coupler 114 and the receive coupler 118.

FIG. 2 is a functional block diagram of a wireless power transfer system 200, in accordance with some other exemplary implementations. The system 200 may be a wireless power transfer system of similar, operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that may be adjusted in response to a frequency control signal 223. The oscillator 222 provides the oscillator signal to the driver circuit 224. The driver circuit 224 may be configured to drive the transmit coupler 214 at a resonant frequency of the transmit coupler 214 based on an input voltage signal (V_{D}) 225.

The filter and matching circuit 226 filters out harmonics or other unwanted frequencies and matches the impedance of the transmit circuitry 206 to the impedance of the transmit coupler 214. As a result of driving the transmit coupler 214, the transmit coupler 214 generates a wireless field 205 to wirelessly output power at a level sufficient for charging a battery 236.

The receiver 208 comprises receive circuitry 210 that includes a matching circuit 232 and a rectifier circuit 234. The matching circuit 232 may match the impedance of the receive circuitry 210 to the impedance of the receive coupler 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236.

FIG. 3 is a schematic diagram, of a portion of the transmit circuitry 206 or the receive circuitry 210 of FIG. 2, in accordance with some exemplary implementations. As illustrated in FIG. 3, transmit or receive circuitry 350 may include a coupler 352. The coupler 352 may also be referred to or be configured as a “conductor loop”, an antenna, a coil, an inductor, or a “magnetic” coupler. The term “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit that selects a signal 358 at a resonant frequency. For larger sized couplers using large diameter couplers exhibiting larger inductance, the value of capacitance needed to produce resonance may be lower. Furthermore, as the size of the coupler increases, coupling efficiency may increase. This is mainly true if the size of both transmit and receive couplers increase. For transmit couplers, the signal 358, with a frequency that substantially corresponds to the resonant frequency of the coupler 352, may be an input to the coupler 352.

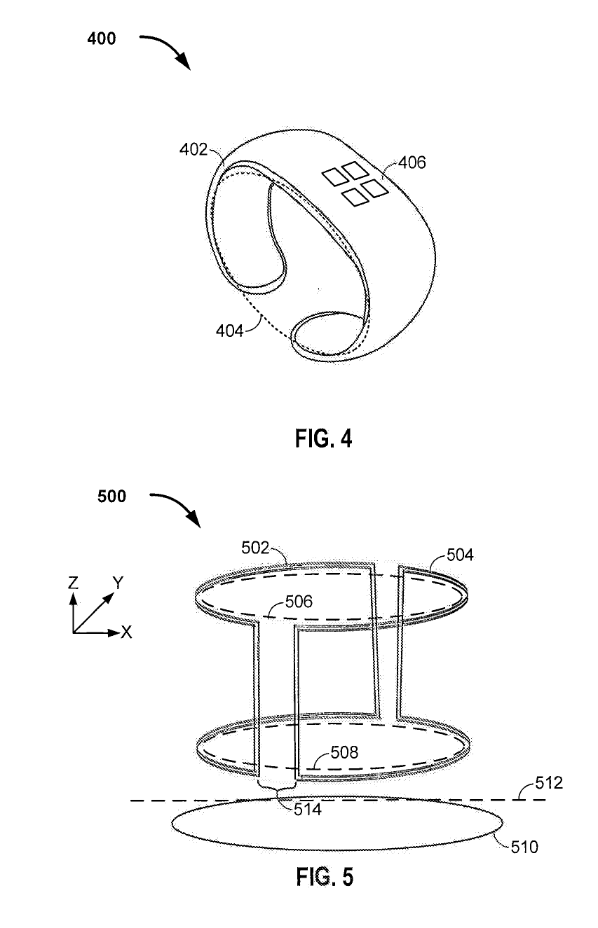

FIG. 4 is an illustration of a wearable device 400 including a receive coil, in accordance with some implementations. The wearable device 400 may be a watch, a bracelet, a band or some other type of wearable apparatus that does not provide electrical connection for an internalized inductive wireless charging power transfer coil between the ends of the band 402. The band 402 comprises a band, a bracelet, or a strap having two ends and, in some implementations, a clasp (not shown) configurable to secure the wearable device 400 to a user. In some implementations, secure means to enable the wearable device 400 to be worn without falling off, to hold the wearable device 400 securely to an appendage, as when a watch is worn on an arm, for example. As shown in FIG. 4, the band 402 has a substantially curved cross section 404. For the purposes of this application, “substantially curved cross section” may be taken to mean that overall the cross section 404 curves (e.g., is not flat) but may have one or more portions that are relatively flat or straight, such as at the face 406 or at a clasp for physically connecting the ends of the band 402 (no clasp shown in FIG. 4) of the wearable device 400. To increase mutual coupling between a receive coil and a transmitter coil during inductive power transfer, particularly in a loosely coupled system, it can be beneficial to increase the size of the receive coil (e.g., increase the effective diameter) to as large as is feasible to be able to capture sufficient magnetic flux. However, because of the smaller form factor of a wearable device 400, it may be difficult to create a receive coil of sufficient size to have sufficient mutual coupling with the transmit coil for adequate power transfer. Moreover, as just described, the wearable device 400 may require a gap between ends of the band 402 or other fastener structure for attaching or securing the band 402 around a wrist or other body part of a user. Providing an electrical connection between ends of the band 402 to create a mechanism for a large receive coil around the entire wearable device 400 may be difficult. Thus, according to the implementations described in the following figures, a resonator comprising receive coils within the band 402 (or strap) of the wearable device 400 may be designed without any electrical contact between the receive coils at a clasp of the band or strap or at a gap in the band or strap where a clasp may otherwise be located. This may enable implementations of wearable devices that incorporate larger receive coils that, have sufficient mutual coupling with transmit coils for adequate wireless power transfer while avoiding the need for electrical connections as just described.

FIG. 5 is an illustration 500 of a first receive coil 502 and a second receive coil 504 within a band in a wearable device (e.g., the wearable device 400 of FIG. 4) and a planar transmit coil 510 of a wireless transmitter, in accordance with some implementations. In some implementations, the first receive coil 502 and the second receive coil 504 may be disposed within the band 402 (or strap) of the wearable device 400 of FIG. 4. Thus, as shown in FIG. 4, the wearable device 400 would be laid on its side such that the substantially curved cross section 404 of the band 402 (or strap) substantially coincides with the dotted lines 506 and 508. In some implementations, the first receive coil 502 and the second receive coil 504 may be a part of a capacitive/inductive resonator of a resonant inductive power transfer system. Thus, since resonant inductive wireless power transfer may be more efficient than non-resonant inductive wireless power transfer, one or more resonant circuits may include the first receive coil 502 and the second receive coil 504. In some other implementations, the first receive coil 502 and the second receive coil 504 may be a part of a non-resonant inductive power transfer system. As shown, no direct electrical connection exists between the first receive coil 502 and the second receive coil 504 at a gap 514 where a clasp of the band (e.g., the band 402 of FIG. 4) or a gap in the band itself may be located. A transmit coil 510 of a wireless transmitter is also shown disposed under the first receive coil 502 and the second receive coil 504 along with an example charging surface 512 of the wireless transmitter.

In some implementations, the first receive coil 502 and the second receive coil 504 may be disposed vertically (with respect to the orientation shown in FIG. 5), such, that a cross section enclosed by the first receive coil 502 and the second receive coil 504 may substantially extend in the Z and Y directions and curve into the X direction (with respect to the X, Y, and Z axes shown). A cross section enclosed by the transmit coil 510 may lie in the X-Y plane such that the transmit coil 510 is disposed substantially perpendicularly to cross sections enclosed by the first receive coil 502 and the second receive coil 504. Thus, cross sections enclosed by each of the first receive coil 502 and the second receive coil 504 are also substantially perpendicular to the substantially curved cross section 404 of the band 402. The first receive coil 502 and the second receive coil 504 may be shaped such, that an edge of the first receive coil 502 extending along a first portion of the band (delineated by the extent of the top edge of coil 502 as illustrated in FIG. 5) and an edge of the second receive coil extending along a second portion of the band (delineated by the extent of the top edge of coil 504 as illustrated in FIG. 5) form a majority of a perimeter of a substantially elliptical composite cross section (e.g., shown by dotted line 506). The bottom edges of the first receive coil 502 and the second receive coil 504 may also form a similar composite cross section when viewed from above (e.g., shown by dotted line 508). Thus, these composite elliptical cross sections, shown by dotted lines 506, 508 formed by the top and bottom edges of the first receive coil 502 and the second receive coil 504 may encircle or enclose vertically (Z-axis) polarized magnetic flux generated by the transmit coil 510. These composite elliptical cross sections may be substantially perpendicular to the planes of the cross sections enclosed by the first receive coil 502 and the second receive coil 504 and parallel to a plane of the transmit coil 510 (e.g., a plane in which the transmit coil 510 is wound). Moreover, in some implementations, the first receive coil 502 may be wound in an opposite clockwise or counterclockwise direction (as viewed from a direction normal to the cross sections enclosed by the first receive coil and the second receive coil, e.g., along the X-axis as shown in FIG. 5) as compared to the second receive coil 504.

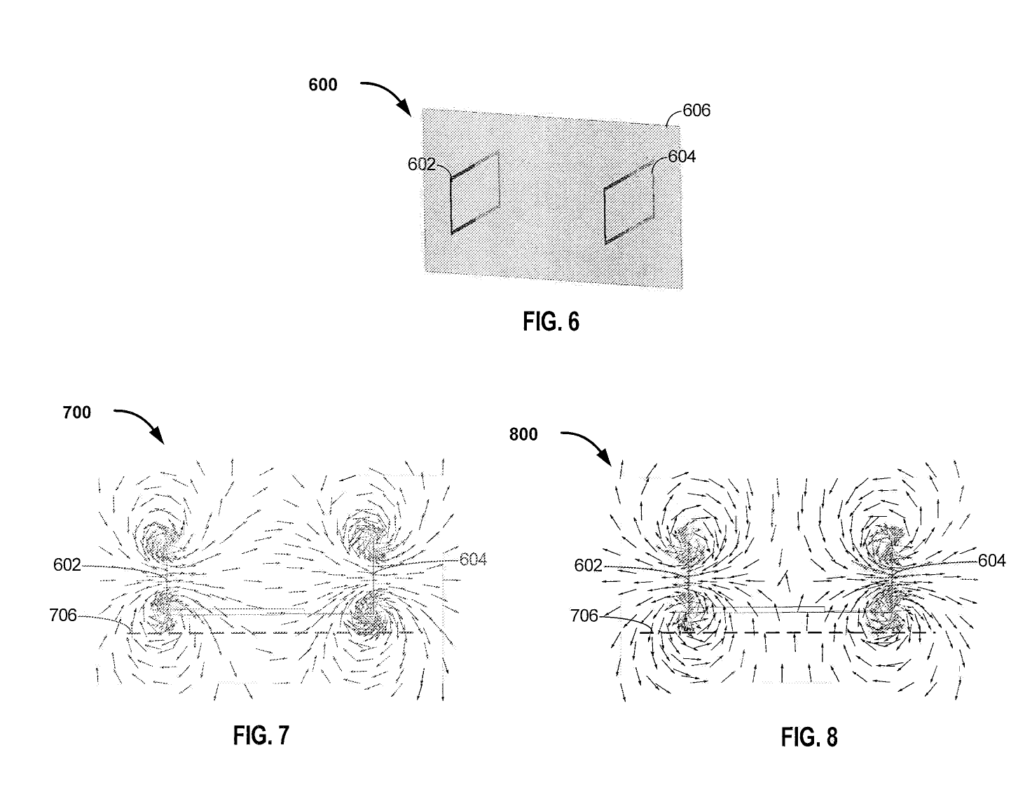

FIG. 6 shows a flattened version 600 of a first receive coil 602 and a second receive coil 604 in a wearable device and a cut-away plane 606 pertaining to magnetic flux shown in FIGS. 7 and 8, in accordance with some implementations. The first receive coil 602 and the second receive coil 604 may correspond to flattened versions of the first receive coil 502 and the second receive coil 504 previously described in connection with FIG. 5 (e.g., the first receive coil 502 and the second receive coil 504 flattened into the Y-Z plane and shown as not curving into the X-direction for simplicity. A cut-away plane 606 shows a position on the first receive coil 602 and the second receive coil 604 corresponding to the views shown in FIGS. 7 and 8 below. Thus, the cut-away plane 606 would lie in the X-Z plane of FIG. 5.

FIG. 7 is an illustration 700 of exemplary magnetic field vectors that would be generated by currents induced in the first receive coil 602 and the second receive coil 604 of FIG. 6 under influence of a magnetic field generated by a transmit coil disposed below a charging surface 706, in accordance with some implementations. In FIG. 7 the first receive coil 602 and the second receive coil 604 are wound in a same clockwise or counter clockwise direction (as viewed from the left or right side of FIG. 7 looking horizontally toward the opposite side). As can be seen, since the first receive coil 602 and the second receive coil 604 are wound in the same direction, the currents will be induced in each coil in the same direction, which can be inferred by the magnetic field vectors pointing in substantially the same relative directions for and with respect to each of the first receive coil 602 and the second receive coil 604. In such implementations, there may be substantially no mutual inductance between the combined first and second coils 602, 604 (e.g., vertical coils) and the transmit coil disposed below a charging surface 706. This is because the induced magnetic flux from the first coil 602 is coming, down and the magnetic flux from the second coil 604 is coming up in the center of the charging area, resulting in a very small or zero net vertical flux.

FIG. 8 is another illustration 800 of exemplary magnetic field vectors that would be generated by currents induced in the first receive coil 602 and the second receive coil 604 of FIG. 6 under influence of a magnetic field generated by a transmit coil disposed below the charging surface 706, in accordance with some implementations. In FIG. 8 the first receive coil 602 and the second receive coil 604 are wound in opposite clockwise and counter clockwise directions (as viewed from the left or right side of FIG. 8 looking horizontally toward the opposite side). As can be seen, since the first receive coil 602 and the second receive coil 604 are wound in opposite directions, the alternating currents generated will be induced in each coil in opposite directions, which can be inferred by the magnetic field vectors pointing in substantially opposite relative directions for and with respect to each of the first receive coil 602 and the second receive coil 604. In such implementations, there may be a substantial non-zero mutual inductance between the first receive coil 602 or second receive coil 604 and the transmit coil disposed below the charging surface 706 (e.g., 150 nH). Thus, as shown in FIG. 8, each of the first receive coil 602 and the second receive coil 604 are configured to generate an alternating current under influence of a magnetic field polarized in a direction substantially perpendicular to the substantially elliptical cross sections, shown by dotted lines 506, 508 previously described in connection with FIG. 5. Such a magnetic field would also be polarized in a direction substantially parallel to the cross sections enclosed by each of the first receive coil 602 and the second receive coil 604. It is this polarizing in the same direction for the first receive coil 602 and the second receive coil 604 that increases mutual coupling between the first receive coil 602 and/or the second receive coil 604 and the transmit coil disposed below the charging surface 706. Such generated currents may be utilized for charging or powering the wearable apparatus.

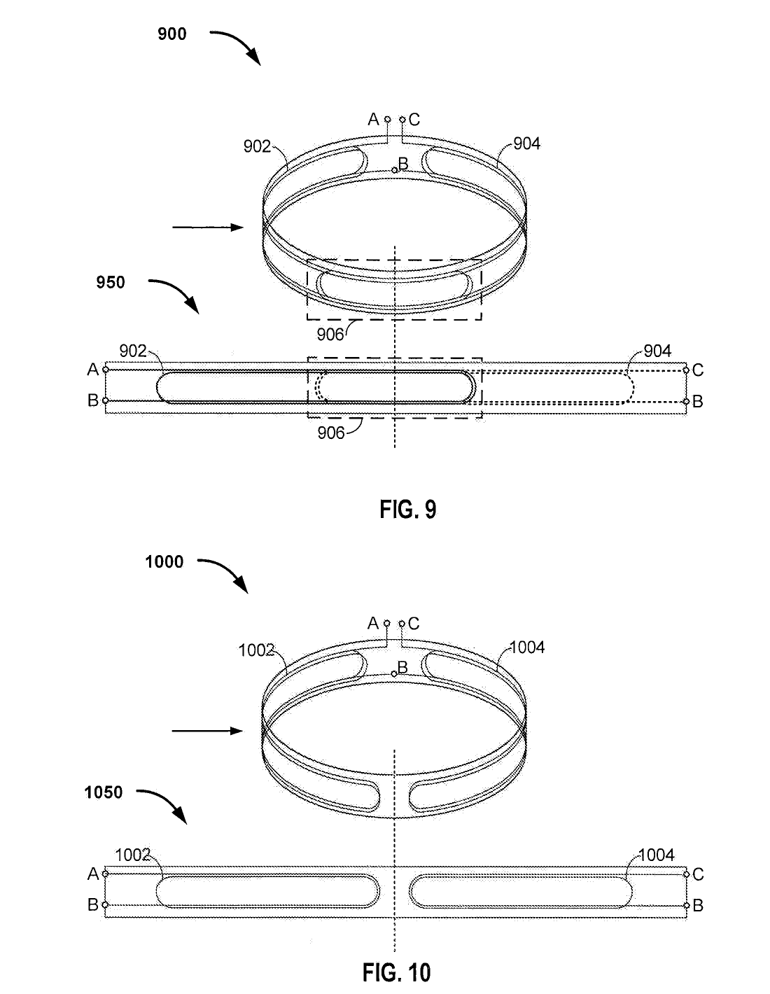

FIG. 9 illustrates a 3 dimensional view 900 and a flattened view 950 of a first receive coil 902 and a second receive coil 904 in a wearable device that partially overlap one another, in accordance with some implementations. In, such implementations, a clasp for wearing the wearable device may be completely eliminated. In order to more easily visualize the arrangement of the first receive coil 902 and the second receive coil 904 two views are shown: the 3 dimensional view 900 and the flattened view 950 illustrating the band as flattened out to show the relative positions of the first receive coil 902 and the second receive coil 904. In the flattened view 950, the points A and C correspond to first and second ends of a single conductor utilized to form the first receive coil 902 and the second receive coil 904. The point B, shown on each side of the band in the flattened view 950, indicates the same point on the conductor as the conductor extends from the first receive coil 902 to the second receive coil 904. The point B is located near a bottom edge of the band and on a side of the band substantially opposite a side where any clasp would normally be positioned. The first receive coil 902 partially overlaps the second receive coil 904 at overlapping portion 906, providing a degree of magnetic but not electric connection between the first receive coil 902 and the second receive coil 904 at the overlapping portion 906. Although FIG. 9 is shown with the first receive coil 902 and the second receive coil 904 wired in series, this is not required. The first receive coil 902 and the second receive coil 904 may also be wound from completely different conductors. This may allow for a clasp which may allow for overlapping but without a direct electrical connection between the clasp ends as described above. FIG. 9 shows that the windings of the first, receive coil 902 are wound from the top in a clockwise fashion when looking in the direction of the arrow. The conductor is then routed across the bottom of the backside of the wearable device band (through point B) and the second receive coil 904 is wound from the bottom in a counterclockwise fashion when looking in the direction of the arrow, as previously described in connection with FIG. 8. It should be noted that view 950 shows the second coil 904 wound in the same direction as the first coil 902. However, this is only because the circular band is flattened out into a straight line in view 950. Thus, view 950 would actually show the second coil 904 as viewed from the opposite direction as that indicated by the arrow. Table 1 shows exemplary values for maximum and minimum mutual inductances between the receiver coil (902 and 904) and various transmitters for the implementations shown in FIG. 9.

TABLE 1

| | | | | | | Embed- | |
|---|---|---|---|---|---|---|---|
| | | PTU | | PTU | | ded | |
| | | 3502 | | 3501A | | PTU | |
| L (μH) | R(Ω) | Max M | Min M | Max M | Min M | Max M | Min M |
| M requirement | | 380 | 70 | 665 | 108 | 281 | 54 |
| FIG. 9 | 2.0 | 259 | 84 | 453 | 328 | 90 | 58 |

FIG. 10 illustrates a 3 dimensional view 1000 and a flattened view 1050 of a first receive coil 1002 and a second receive coil 1004 in a wearable device that do not overlap one another, in accordance with some implementations. In order to more easily visualize the arrangement of the first receive coil 1002 and the second receive coil 1004 two views are shown: the 3 dimensional view 1000 and a flattened view 1050 illustrating the band as flattened out to show the relative positions of the first receive coil 1002 and the second receive coil 1004. In the flattened view 1050, the points A and C correspond to first and second ends of a single conductor utilized to form the first receive coil 1002 and the second receive coil 1004. The point B, shown on each side of the band in the flattened view 1050, indicates the same point on the conductor as the conductor extends from the first receive coil 1002 to the second receive coil 1004. The point B is located near a bottom edge of the band and on a side of the band substantially opposite a side where any clasp would normally be positioned. The first receive coil 1002 does, not overlap the second receive coil 1004. Moreover, the first receive coil 1002 and the second receive coil 1004 are not electrically connectable to one another at distal ends of the band. Although FIG. 10 is shown with the first receive coil 1002 and the second receive coil 1004 wired in series, this is not required. The first receive coil 1002 and the second receive coil 1004 may also be wound from completely different conductors. FIG. 10 shows that the windings of the first receive coil 1002 are wound from the top in a clockwise fashion when looking in the direction of the arrow. The conductor is then routed across the bottom of the backside of the wearable device band and the second receive coil 1004 is wound from the bottom in a counterclockwise fashion when looking in the direction of the arrow, as previously described in connection with FIG. 8. As shown in both FIGS. 9 and 10, there is no electrical contact at the side of the coils closest to the viewer (e.g., at the overlap 906 in FIG. 9 or the gap between the first receive coil 1002 and the second receive coil 1004 at the same location in FIG. 10). It should be noted that view 1050 shows the second coil 1004 wound in the same direction as the first coil 1002. However, this is only because the circular band is flattened out into a straight line in view 1050. Thus, the view 1050 would actually show the second coil 1004 as viewed from the opposite direction as that indicated by the arrow. Table 2 shows exemplary values for maximum and minimum mutual inductances between the receiver coil (902 and 904) and various transmitters for the implementations shown in FIG. 10.

TABLE 2

| | | PTU | | PTU | |
|---|---|---|---|---|---|
| | | 3502 | | 3501A | |
| L (μH) | R (Ω) | Max M | Min M | Max M | Min M |
| M requirement | | 380 | 70 | 665 | 108 |
| FIG. 10 | 1.3 | 152 | 81 | 297 | 230 |

FIG. 11 illustrates a 3 dimensional view 1100 and a flattened view 1150 of a parasitic coil 1106 that partially overlaps each of a first receive coil 1102 and a second receive coil 1104 in a wearable device, in accordance with some implementations. In order to more easily visualize the arrangement of the first receive coil 1102 and the second receive coil 1104 two views are shown: the 3 dimensional view 1100 and a flattened view 1150 illustrating the band as flattened out to show the relative positions of the first receive coil 1102 and the second receive coil 1104. In the flattened view 1150, the points A and C correspond to first and second ends of a single conductor utilized to form the first receive coil 1102 and the second receive coil 1104. The point B, shown on each side of the band in the flattened view 1150, indicates the same point on the conductor as the conductor extends from the first receive coil 1102 to the second receive coil 1104. The point B is located near a bottom edge of the band and on a side of the band substantially opposite a side where any clasp would normally be positioned. FIG. 11 shows the first receive coil 1102 and the second receive coil 1104, which may have substantially the same arrangement as that previously described for the first receive coil 1002 and the second receive coil 1004 in connection with FIG. 10. FIG. 11 additionally includes a parasitic coil 1106 that partially overlaps each of the first receive coil 1102 and the second receive coil 1104. The parasitic coil 1106 in some implementations is not directly electrically connected to any of the receive coils 1102, 1104 and may additionally not be directly driven by any driver circuit, or directly output any power to a rectification circuit. The parasitic coil 1106, by partially overlapping the first receive coil 1102 and the second receive coil 1104, links magnetic fields between the first receive coil 1102 and the second receive coil 1104, mimicking an electrical connection at the gap between the first receive coil 1102 and the second receive coil 1104. This effect is achieved since currents induced in the first receive coil 1102 cause a magnetic field that induces a current in the parasitic coil 1106, which in turn causes another magnetic field that induces a current in the second receive coil 1104, and vice versa. This current induction from one receive coil to the parasitic coil 1106 and then to the other receive coil mimics an electrical connection between the first receive coil 1102 and the second receive coil 1104. It should be noted that view 1150 shows the second coil 1104 wound in the same direction as the first coil 1102. However, this is only because the circular band is flattened out into a straight line in view 1150. Thus, the view 1150 would actually show the second coil 1104 as viewed from the opposite direction as that indicated by the arrow.

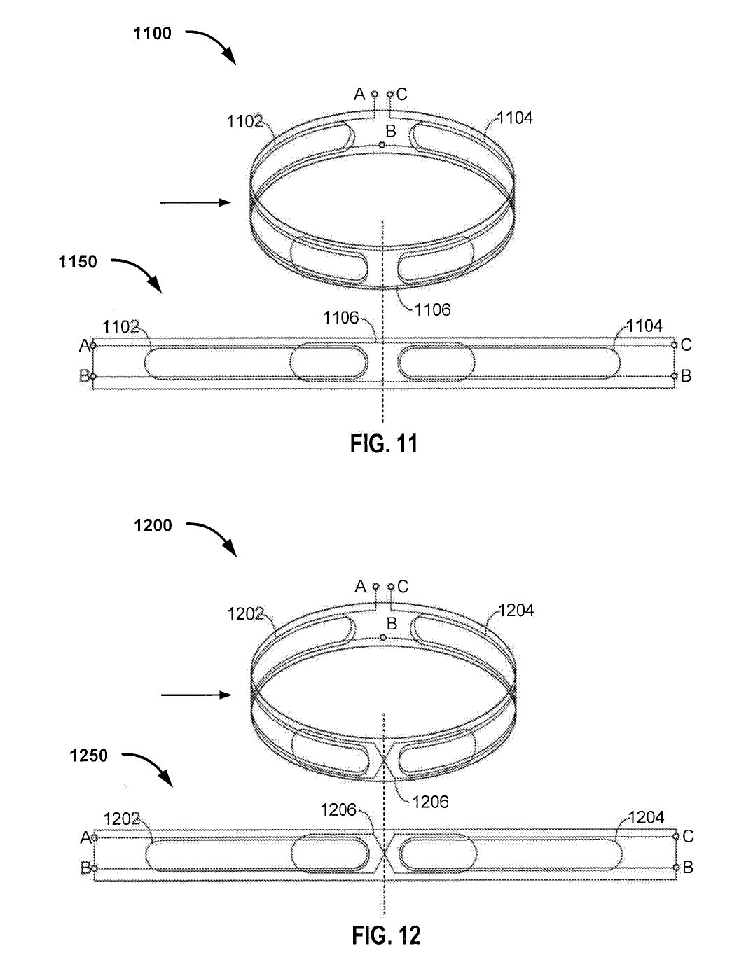

FIG. 12 illustrates a 3 dimensional view 1200 and a flattened view 1250 of a parasitic coil 1206 that partially overlaps each of a first receive coil 1202 and a second receive coil 1204 in a wearable device, in accordance with some implementations. In order to more easily visualize the arrangement of the first receive coil 1202 and the second receive coil 1204 two views are shown: the 3 dimensional view 1200 and a flattened view 1250 illustrating the band as flattened out to show the relative positions of the first receive coil 1202 and the second receive coil 1204. In the flattened view 1250, the points A and C correspond to first and second ends of a single conductor utilized to form the first receive coil 1202 and the second receive coil 1204. The point B, shown on each side of the band in the flattened view 1250, indicates the same point on the conductor as the conductor extends from the first receive coil 1202 to the second receive coil 1204. The point B is located near a bottom edge of the band and on a side of the band substantially opposite a side where any clasp would normally be positioned. FIG. 12 shows the first receive coil 1202 and the second receive coil 1204, which may have substantially the same arrangement as that previously described for the first receive coil 1002 and the second receive coil 1004 in connection with FIG. 10. FIG. 12 additionally includes a parasitic coil 1206 that partially overlaps each of the first receive coil 1202 and the second receive coil 1204 and that crosses itself at the gap along the substantially curved cross section of the band defined between the first receive coil 1202 and the second receive coil 1204. The parasitic coil 1206 partially overlapping the first receive coil 1202 and the second receive coil 1204 link magnetic fields between the first receive coil 1202 and the second receive coil 1204, mimicking an electrical connection at the gap between the first receive coil 1202 and the second receive coil 1204 overlapped by the parasitic coil 1206. It should be noted that view 1250 shows the second coil 1204 wound in the same direction as the first coil 1202. However, this is only because the circular band is flattened out into a straight line in view 1250. Thus, the view 1250 would actually show the second coil 1204 as viewed from the opposite direction as that indicated by the arrow.

In some implementations, the first coil 502, 602, 902, 1002, 1102, 1202 may also be known as, or comprise at least a portion of “first means for generating a current under influence of a magnetic field.” Similarly, the second coil 504, 904, 1004, 1104, 1204 may also be known as, or comprise at least a portion of “second means for generating a current under influence of the magnetic field.” In some implementations, the parasitic coil 1106, 1206 may also be known as, or comprise at least a portion of “means for increasing a mutual inductive coupling between the first means for generating a current and a portion of the second means for generating a current.”

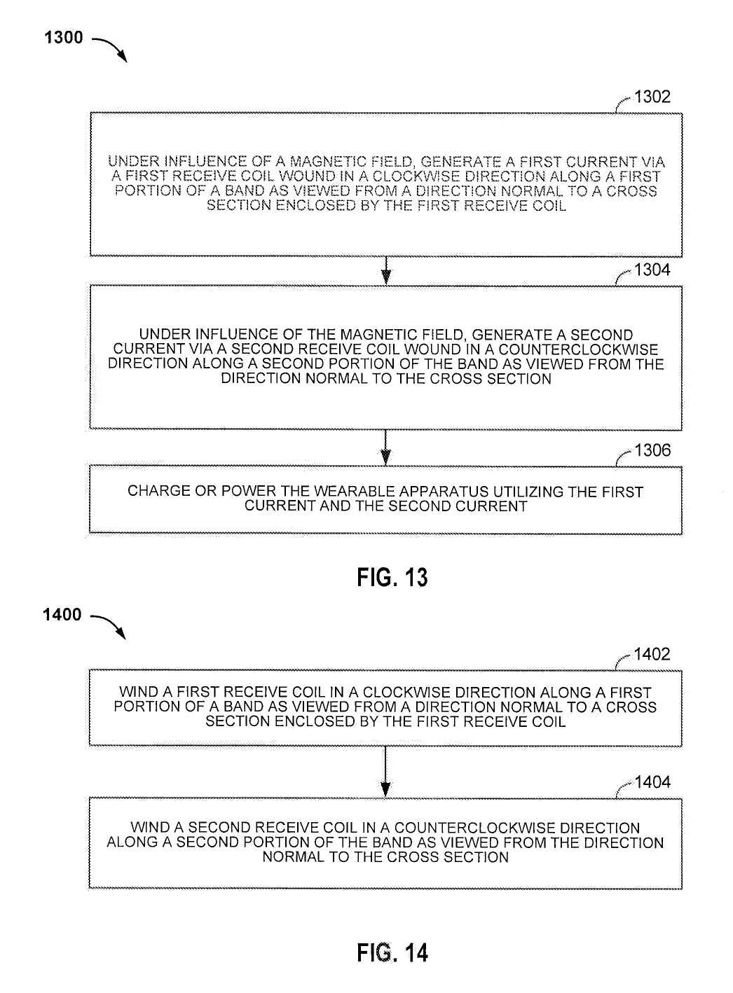

FIG. 13 is a flowchart 1300 depicting a method for wirelessly receiving charging power by a wearable apparatus, in accordance with some exemplary implementations. The flowchart 1300 is described herein with reference to any of FIGS. 4-12. Although the flowchart 1300 is described herein with reference to a particular order, in various implementations, blocks herein may be performed in a different order, or omitted, and additional blocks may be added.

Block 1302 includes, under influence of a magnetic field, generating a first current via a first receive coil wound in a clockwise direction along a first portion of a band as viewed from a direction normal to a cross section enclosed by the first receive coil. For example, as previously described in connection with FIGS. 9-12, a current may be generated under influence of a magnetic field via a first receive coil 902, 1002, 1102, 1202 wound in a clockwise direction along a first portion of a band as viewed from a direction (see arrows) normal to a cross section enclosed by the first receive coil 902, 1002, 1102, 1202. The flowchart 1300 may advance to block 1304.

Block 1304 includes, under influence of the magnetic field, generating a second current via a second receive coil wound in a counterclockwise direction along a second portion of the band as viewed from the direction normal to the cross section. For example, as previously described in connection with FIGS. 9-12, a second current may be generated under influence of the magnetic field via a second receive coil 904, 1004, 1104, 1204 wound in a counterclockwise direction along a second portion of the band as viewed from the direction (e.g., the same arrow when wrapped and not laid out flat).

In some implementations, e.g., FIGS. 10 and 12, the first receive coil 1002, 1202 does not overlap the second receive coil 1004, 1204. In some other implementations, e.g., FIGS. 9 and 11, the first receive coil 902, 1102 overlaps a portion of the second receive coil 904, 1104. As shown by FIGS. 4-6 and 9-12, an edge of the first receive coil 502, 602, 902, 1002, 1102, 1202 extending along the first portion of the band 402 and an edge of the second receive coil 504, 902, 1002, 1102, 1202 extending along the second portion of the band 402 form a majority of a perimeter of a substantially elliptical cross section, shown by dotted lines 506, 508 that is substantially perpendicular to the cross section enclosed by the first receive coil 502, 602, 902, 1002, 1102, 1202. The substantially elliptical cross section, shown by dotted lines 506 is also, in some cases, substantially perpendicular to the cross section enclosed by the second receive coil 504, 904, 1004, 1104, 1204. The first receive coil 1002, 1202 is not electrically connectable to the second receive coil 1004 at distal ends of the band (shown as the dotted lines in each of FIGS. 9-12). The flowchart 1300 may advance to block 1306.

Block 1306 includes charging or powering the wearable apparatus utilizing the first current and the second current. For example, as previously described in connection with FIGS. 4 and 5, the wearable device 400 may utilize the current generated by the first receive coil 502, 602, 902, 1002, 1102, 1202 and the second receive coil 504, 904, 1004, 1104, 1204 to charge or power the wearable device 400.

In some implementations, the flowchart 1300 may additionally include increasing a mutual inductive coupling between the first receive coil 1102, 1202 and the second receive coil 1104, 1204 via a parasitic coil 1106, 1206 overlapping a portion of the first receive coil 1102, 1202 and a portion of the second receive coil 1104, 1204. As shown in FIG. 12, in some implementations, the parasitic coil 1206 crosses itself in a gap defined between the first receive coil 1202 and the second receive coil 1204.

FIG. 14 is a flowchart 1400 depicting a method for manufacturing a wearable apparatus configured to wirelessly receive charging power, in accordance with some exemplary implementations. The flowchart 1400 is described herein with reference to any of FIGS. 4-12. Although the flowchart 1400 is described herein with reference to a particular order, in various implementations, blocks herein may be performed in a different order, or omitted, and additional blocks may be added.

Block 1402 includes, winding a first receive coil in a clockwise direction along a first portion of a band as viewed from a direction normal to a cross section enclosed by the first receive coil. For example, as previously described in connection with any of FIG. 4-6 or 9-12, the first receive coil 502, 602, 902, 1002, 1102, 1202 may be wound along a first portion of the band 402 of the wearable device 400. The flowchart 1400 may advance to block 1404.

Block 1404 includes winding a second receive coil in a counterclockwise direction along a second portion of the band as viewed from the direction normal to the cross section. For example, as previously described in connection with any of FIG. 4-6 or 9-12, a second receive coil 504, 904, 1004, 1104, 1204 may be wound in a counterclockwise direction (e.g., a direction opposite the first coil) along a second portion of the band 402 as viewed from the direction (e.g., when viewed from the same direction as the winding of the first coil is viewed when the band 402 is wrapped and not laid flat).

In some implementations, the flowchart 1400 may additionally include winding a parasitic coil 1106, 1206 along the band 402 to overlap a portion of the first receive coil 1102, 1202 and a portion of the second receive coil 1104, 1204. In some implementations, the parasitic coil 1206 crosses itself in a gap defined between the first receive coil 1202 and the second receive coil 1204.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced, throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, one or more implementations achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. A wearable apparatus configured to wirelessly receive charging power, comprising:
a band;
a first receive coil wound in a clockwise direction along a first portion of the band as viewed from, a direction normal to a cross section enclosed by the first receive coil; and
a second receive coil wound in a counterclockwise direction along a second portion of the band as viewed from the direction normal to the cross section.

2. The wearable apparatus of claim 1, wherein an edge of the first receive coil extending along the first portion of the band and an edge of the second receive coil extending along the second portion of the band form a majority of a perimeter of a substantially elliptical cross section that is substantially perpendicular to the cross section enclosed by the first receive coil.

3. The wearable apparatus of claim 2, wherein the first receive coil and the second receive coil are each configured to generate an alternating current under influence of a magnetic field polarized in a direction substantially perpendicular to the substantially elliptical cross section.

4. The wearable apparatus of claim 3, wherein the magnetic field is polarized in a direction substantially parallel to the cross section enclosed by the first receive coil.

5. The wearable apparatus of claim 1, wherein the first receive coil does not overlap the second receive coil.

6. The wearable apparatus of claim 1, wherein the first receive coil overlaps a portion of the second receive coil.

7. The wearable apparatus of claim 1, further comprising a parasitic coil overlapping a portion of the first receive coil and a portion of the second receive coil.

8. The wearable apparatus of claim 7, wherein the parasitic coil crosses itself in a gap defined between the first receive coil and the second receive coil.

9. The wearable apparatus of claim 1, wherein the first receive coil is not electrically connectable to the second receive coil at distal ends of the band.

10. The wearable apparatus of claim 1, wherein the first receive coil and the second receive coil are configured to inductively couple power from a transmitter to power or charge the wearable apparatus.

11. The wearable apparatus of claim 1, further comprising a power receive circuit configured to receive current from the first receive coil and from the second receive coil when the first receive coil and the second receive coil are under influence of a magnetic field in order to power or charge the wearable apparatus.

12. The wearable apparatus of claim 1, further comprising one or more resonant circuits comprising the first receive coil and the second receive coil.

13. The wearable apparatus of claim 1, wherein the band comprises a band, a bracelet, or a strap having two ends and a clasp configurable to secure the wearable apparatus to a user.

14. A method for wirelessly receiving charging power by a wearable apparatus, comprising:
under influence of a magnetic field, generating a first current via a first receive coil wound in a clockwise direction along a first portion of a band as viewed from a direction normal to a cross section enclosed by the first receive coil;
under influence of the magnetic field, generating a second current via a second receive coil wound in a counterclockwise direction along a second portion of the band as viewed from the direction normal to the cross section; and
charging or powering the wearable apparatus utilizing the first current and the second current.

15. The method of claim 14, wherein an, edge of the first receive coil extending along the first portion of the band and an edge of the second receive coil extending along the second portion of the band form a majority of a perimeter of a substantially elliptical cross section that is substantially perpendicular to the cross section enclosed by the first receive coil.

16. The method of claim 15, wherein the magnetic field is polarized in a direction substantially perpendicular to the substantially elliptical cross section.

17. The method of claim 16, wherein the magnetic field is polarized in a direction substantially parallel to the cross section enclosed by the first receive coil.

18. The method of claim 14, wherein the first receive coil does not overlap the second receive coil.

19. The method of claim 14, wherein the first receive coil overlaps a portion of the second receive coil.

20. The method of claim 14, further comprising increasing a mutual inductive coupling between the first receive coil and the second receive coil via a parasitic coil overlapping a portion of the first receive coil and a portion of the second receive coil.

21. The method of claim 20, wherein the parasitic coil crosses itself in a gap defined between the first receive coil and the second receive coil.

22. The method of claim 14, wherein the first receive coil is not electrically connectable to the second receive coil at distal ends of the band.

23. The method of claim 14, further comprising receiving, by a power receive circuit, the first current, from the first receive coil and the second current from the second receive coil to power or charge the wearable apparatus.

24. A method for fabricating a wearable apparatus configured to wirelessly receive charging power, comprising:
winding a first receive coil in a clockwise direction along a first portion of a band as viewed from a direction normal to a cross section enclosed by the first receive coil; and
winding a second receive coil in a counterclockwise direction along a second portion of the band as viewed from the direction normal to the cross section.

25. The method of claim 24, wherein an edge of the first receive coil extending along the first portion of the band and an edge of the second receive coil extending along the second portion of the band form a majority of a perimeter of a substantially elliptical cross section that is substantially perpendicular to the cross section enclosed by the first receive coil.

26. The method of claim 24, wherein, the first receive coil does not overlap the second receive coil.

27. The method of claim 24, wherein the first receive coil overlaps a portion of the second receive coil.

28. The method of claim 24, further comprising winding a parasitic coil along the band to overlap a portion of the first receive coil and a portion of the second receive coil.

29. The method of claim 28, wherein the parasitic coil crosses itself in a gap defined between the first receive coil and the second receive coil.

30. The method of claim 24, wherein the first receive coil is not electrically connectable to the second receive coil at distal ends of the band.

31. The method of claim 24, further compromising forming one or more resonant circuits from at least the first receive coil and to the second receive coil.

32. The method of claim 24, wherein the band comprises a band, a bracelet, or a strap having two ends and a clasp configurable to secure the wearable apparatus to a user.

33. A wearable apparatus configured to wirelessly receive charging power, comprising:
first means for generating a current under influence of a magnetic field, the first means wound in a clockwise direction along a first portion of a band as viewed from a direction normal to a cross section enclosed by the first means; and
second means for generating a current under influence of the magnetic field, the second means wound in a counterclockwise direction along a second portion of the band as viewed from the direction normal to the cross section.

34. The wearable apparatus of claim 33, wherein an edge of the first means for generating a current extending along the first portion of the band and an edge of the second means for generating a current extending along the second portion of the band form a majority of a perimeter of a substantially elliptical cross section that is substantially perpendicular to the cross section enclosed by the first means for generating a current.

35. The wearable apparatus of claim 34, wherein the magnetic field is polarized in a direction substantially perpendicular to the substantially elliptical cross section.

36. The wearable apparatus of claim 35, wherein the magnetic field is polarized in a direction substantially parallel to the cross section enclosed by the first means for generating a current.

37. The wearable apparatus of claim 33, wherein the first means for generating a current does not overlap the second means for generating a current.

38. The wearable apparatus of claim 33, wherein the first means for generating a current overlaps a portion of the second means for generating a current.

39. The wearable apparatus of claim 33, further comprising means for increasing a mutual inductive coupling between the first means for generating a current and a portion of the second means for generating a current.

40. The wearable apparatus of claim 39, wherein the means for increasing a mutual inductive coupling crosses itself in a gap defined between the first means for generating a current and the second means for generating a current.
